(19) United States
(12) Patent Application Publication
(10) Pub. No.: US 2025/0355883 A1
(43) Pub. Date: Nov. 20, 2025

(54) SEARCH ENGINE FOR CONVERSATIONS BASED ON DATA TOPIC SEGMENT IDENTIFICATION

(71) Applicant: International Business Machines Corporation, Armonk, NY (US)

(72) Inventors: Ilse Breedvelt, Manotick (CA); Rami Abou-Nassif, Ottawa (CA); Avery Wong Hagleitner, San Jose, CA (US); Tanu Malhotra, BRAMPTON (CA); Hosam Aly, Kanata (CA)

(21) Appl. No.: 18/663,288

(22) Filed: May 14, 2024

(51) Int. Cl. G06F 16/2457; G06F 16/22; G06F 16/28

(52) U.S. Cl. CPC G06F 16/24575; G06F 16/22; G06F 16/287

(57) ABSTRACT

According a present invention embodiment, a system for searching conversations for desired content monitors one or more conversations and identifies changes in topics in the one or more conversations based on inquiries from one or more users. The topics pertain to business concepts. The one or more conversations are partitioned into segments based on the identified changes in topics. The segments are assigned to the topics based on the segments containing content for the topics. A query including a topic is processed, and the segments of the one or more conversations pertaining to the topic of the query are retrieved based on the assignment of the segments to the topics. Embodiments of the present invention further include a method and computer program product for searching conversations for desired content in substantially the same manner described above.

### BACKGROUND

### 1. Technical Field

Present invention embodiments relate to artificial intelligence (AI) assistants, and more specifically, to a search engine for human-AI conversations based on identifying data topic segments during the conversations.

### 2. Discussion of the Related Art

Generative artificial intelligence (AI) conversations are used for various scenarios (e.g., consumer service/product support, chatbots, etc.). However, searching conversations for desired topics or content provides challenges. For example, the conversations are organic and can cover many topics, resulting in long conversations that require extensive scrolling to return to content provided by an AI system for a desired topic. Further, the conversations may include numerous utterances and exchanges of content in natural dialogues that are irrelevant to a current topic. In addition, as a conversation moves from one topic to another topic, return to the topics in the conversation is extremely complex. This is due to a key word search of the conversation producing multiple results, thereby causing scrolling and confusion as to the relevance of each result.

### SUMMARY

According to one embodiment of the present invention, a system for searching conversations for desired content comprises one or more memories and at least one processor coupled to the one or more memories. The system monitors one or more conversations and identifies changes in topics in the one or more conversations based on inquiries from one or more users. The topics pertain to business concepts. The one or more conversations are partitioned into segments based on the identified changes in topics. The segments are assigned to the topics based on the segments containing content for the topics. A query including a topic is processed, and the segments of the one or more conversations pertaining to the topic of the query are retrieved based on the assignment of the segments to the topics. Embodiments of the present invention further include a method and computer program product for searching conversations for desired content in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a system flow diagram of identifying and tracking topics during a conversation according to an embodiment of the present invention.

FIG. 3 is a flow diagram of a method of identifying and tracking topics during a conversation according to an embodiment of the present invention.

FIG. 4 is a flow diagram of a method of identifying topics and grouping related topics during a conversation according to an embodiment of the present invention.

FIG. 5 is a flow diagram of a method of searching a conversation for a desired topic according to an embodiment of the present invention.

FIG. 6 is a graphical illustration of a user interface presenting an example generative artificial intelligence (AI) conversation with corresponding identified topics according to an embodiment of the present invention.

FIG. 7 is graphical illustration of a user interface presenting an example generative artificial intelligence (AI) conversation with corresponding identified topics used to locate desired portions of the conversation according to an embodiment of the present invention.

### DETAILED DESCRIPTION

Generative artificial intelligence (AI) conversations are used for various scenarios (e.g., consumer service/product support, chatbots, etc.). However, searching conversations for desired topics or content provides challenges. For example, the conversations are organic and can cover many topics, resulting in long conversations that require extensive scrolling to return to content provided by an AI system for a desired topic. Further, the conversations may include numerous utterances and exchanges of content in natural dialogues that are irrelevant to a current topic. In addition, as a conversation moves from one topic to another topic, return to the topics in the conversation is extremely complex. This is due to a key word search of the conversation producing multiple results, thereby causing scrolling and confusion as to the relevance of each result.

Accordingly, an embodiment of the present invention provides a search engine for human-artificial intelligence (AI) conversations based on identifying topic segments pertaining to data (or data insights) during the conversations. An embodiment of the present invention organizes data topics (e.g., topics related to business or other data, etc.) discussed in a human-AI conversation to match with business concepts and/or key performance indicators (KPIs) and metrics and allows a user to use these data topics for business-related activities. The present invention embodiment partitions a human-AI conversation session about structured data (e.g., business intelligence, etc.) into data topic segments using data topic transitions as breaking points. This results in a collection of (related) topic segments that can be revisited and interrogated for recall and analysis.

An embodiment of the present invention enables a user to reuse insights about data (e.g., sales, inventory, etc.) the system shared during a conversation. The user may simply search the conversation and return to a precise location of the insight in the conversation to review the insight and view related parts of the data-focused conversation, re-run an underlying query of an insight (e.g., starting a new conversation, etc.), and/or save the insight for later conversations.

An embodiment of the present invention partitions a human-artificial intelligence (AI) conversation session into data topic segments (e.g., conversation segments pertaining to corresponding topics about data (or business concepts) mentioned during the conversation, etc.). The data topic segments are defined by transitions or switches in queried data topics during the conversation. The topic transition or switch is determined based on rules related to business concepts and data analytics intents. A data topic is determined based on structured data definitions, business intelligence domain concepts, and business-defined key performance indicators (KPIs), metrics, and semantics. Each data topic segment is associated with a conversation session, and the data topic segments are rendered as they are formed during the conversation. Data topic segments may be indicated adjacent to the conversation, and are grouped when data topics overlap. The data topic segments are new objects that are analyzed on their own merit.

Present invention embodiments may provide several advantages. For example, present invention embodiments significantly improve search time. Specific data topics may be easily identified when hidden or embedded in a long conversation (that otherwise requires a user to scroll through multiple keyword search results to find a specific data topic). This saves time and processing effort, and reduces duplication, thereby reducing a need for extra analysis. Present invention embodiments intelligently organize and categorize conversation topics to enable rapid searching and identification of precise locations of content for the topics in the conversation. Conversations may be filtered by data topic, thereby eliminating unnecessary and irrelevant content. The data topic segments can be used for further pattern recognition and analysis.

Further, the conversation may include various data visualizations (e.g., graphs, charts, etc.). The data topics may be used to rapidly locate the visualizations in the conversation. Thus, the data topics enable a search engine to rapidly identify visualizations in a conversation. Further, the data topics may be in the form of links or hyperlinks on a user interface, where actuation of the link provides the content for the corresponding topic (e.g., displays the topic, navigates to the location of the topic in the conversation, etc.).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

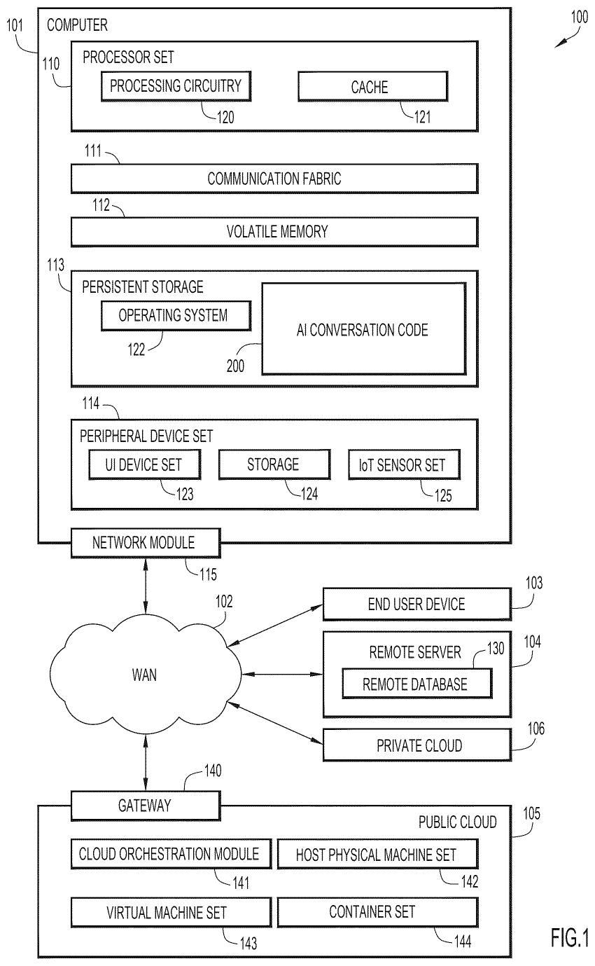

Referring to FIG. 1, computing environment 100 contains an example of an environment for the execution of at least some of the computer code involved in performing the inventive methods, such as artificial intelligence (AI) conversation code 200. In addition to block 200, computing environment 100 includes, for example, computer 101, wide area network (WAN) 102, end user device (EUD) 103, remote server 104, public cloud 105, and private cloud 106.

In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

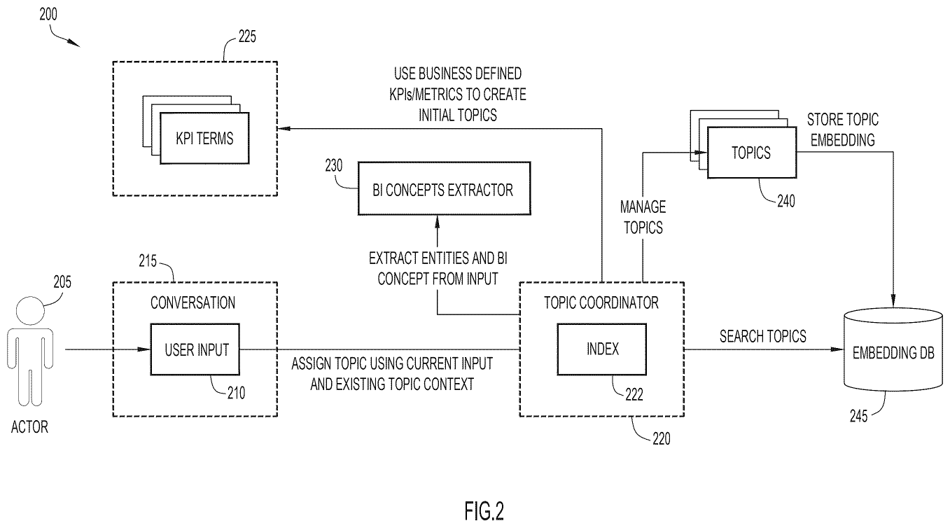

A system flow diagram of identifying and tracking topics during a conversation according to an embodiment of the present invention is illustrated in FIG. 2. Initially, AI conversation code 200 identifies and tracks data topics during a human-artificial intelligence (AI) conversation or other communication session (e.g., chat, conversation, thread, etc.). AI conversation code 200 generates an interactive, natural language, conversation or other communication session 215 with a user 205. User 205 may provide user input 210 to the conversation (e.g., an inquiry, further details and/or inquiries, responses, etc.). AI conversation code 200 may include any conventional or other chatbots, AI assistants, machine learning models, and/or natural language processing techniques to generate conversation 215 (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.).

AI conversation code 200 monitors conversation 215 and identifies data topic segments during the conversation session (e.g., in real-time as the conversation flows, etc.). The data topic segments correspond to segments of the conversation pertaining to a topic about data (e.g., sales, inventory, profits, insights, business concepts, etc.). AI conversation code 200 may include, or be coupled to, a topic coordinator 220, a repository of key performance indicators (KPIs) or other metrics 225, a concept extractor 230, and an embedding database 245. AI conversation code 200 is preferably pre-configured with business terms, and KPIs and metrics, and has an understanding of user personas or roles (e.g., sales roles, marketing roles, etc.). This enables identification and indexing of conversation segments to topics concerning data (e.g., sales, inventory, profits, insights, business concepts, etc.). A data topic segment may include any portion of content of a conversation or other communication session associated with a corresponding data topic (e.g., a series of inquires/answers, insights, visualizations, etc. associated with a data topic).

Topic coordinator 220 initializes embedding database 245 with topics 240 that are generated based on pre-configured terms, KPIs and metrics 225, and known user personas or roles (e.g., sales role or position within an organization, marketing role or position within an organization, etc.). Topic coordinator 220 may generate textual embeddings for topics 240 and store the textual embeddings in embeddings database 245. Basically, words from a topic may be represented by a vector having numeric elements corresponding to a plurality of dimensions or features. Words (or topics) with similar meanings have similar textual embeddings or vector representations. The textual embeddings are produced from machine learning techniques or models (e.g., neural network, etc.) based on an analysis of word usage in a collection of text or documents. The embeddings or vector representations may be pre-existing, and/or produced using any conventional or other tools or techniques (e.g., GLOVE, WORD2VEC, etc.).

The textual embeddings are preferably specialized to business concepts or terms, KPIs and metrics, and/or other industry specific terminology. In this case, business concepts or terms with the same or similar meaning have similar textual embeddings, even though in a general sense (or outside the business context) they may not be similar and not have similar embeddings. The machine learning techniques or models may be trained with an industry specific (or business) glossary to enable generation of the same or similar embeddings for the same or similar business concepts or terms. The specialized embeddings enable AI conversation code 200 to understand the industry specific/business terminology within the conversation for topic identification.

User 205 may add a new input 210 to conversation 215. Concept extractor 230 extracts the entities and business intelligence concepts from user input 210. This may be accomplished using any conventional or other machine learning and/or natural language processing techniques (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.).

Topic coordinator 220 converts the extracted entities to textual embeddings, and searches the existing topics stored in embedding database 245. When a matching topic is identified (e.g., having the same embedding, having an embedding within a threshold distance of the embedding of the entities, etc.), the conversation segment is assigned to the topic within the conversation. For example, topic coordinator 220 may maintain an index 222 of data topics and corresponding segments or portions of the conversation associated with those data topics. The index may contain a listing of topics, and corresponding content of associated segments, or pointers to the locations in the conversation where the corresponding segments reside (e.g., start and end times within the conversation, tags or other identifiers indicating content locations, storage/buffered locations for content, etc.). The segment is assigned to the topic by updating index 222 to indicate the segment is associated with the topic (e.g., add a segment indicator or content for the topic in the index, etc.).

When no matching topic exists, topic coordinator 220 generates a new topic (based on the entities) and adds the new topic (or the embedding of the new topic) to embedding database 245 which can be used for subsequent conversation segments. The conversation segment is assigned to the new topic within the conversation. For example, topic coordinator 220 may maintain index 222 of data topics and corresponding segments or portions of the conversation associated with those data topics in substantially the same manner described above. The segment is assigned to the topic by updating index 222 to include the new topic and indicate the segment associated with the new topic (e.g., add an entry in the index including the new topic and a segment indicator or content for the new topic, etc.).

Topic coordinator 220 compares the new topic with existing topics to determine an existence of a relationship (based on an ontology registry). By way of example, the ontology registry includes nodes representing business concepts, and edges indicating relationships between nodes. The ontology registry may be generated using any conventional or other techniques (e.g., pre-established for specific industries, generated based on industry concepts, generated based on natural language processing, etc.). When the topics are related, the topics are grouped together and presented to the user. The segment may also be assigned to the group of topics by updating index 222 to include an entry for the group of topics and add the segment indicator or content associated with the group of topics.

Topic coordinator 220 may monitor and track topics within plural different conversations 215 in substantially the same manner described above. In this case, topics 240 may be ascertained from and/or applied to the different conversations, where index 222 may assign segments for the different conversations to topics 240 in substantially the same manner described above. For example, a same topic may be within different conversations, and index 222 may assign a plurality of segments from the different conversations to the same topic. Thus, a search for the topic may provide the segments from the different conversations corresponding to the topic.

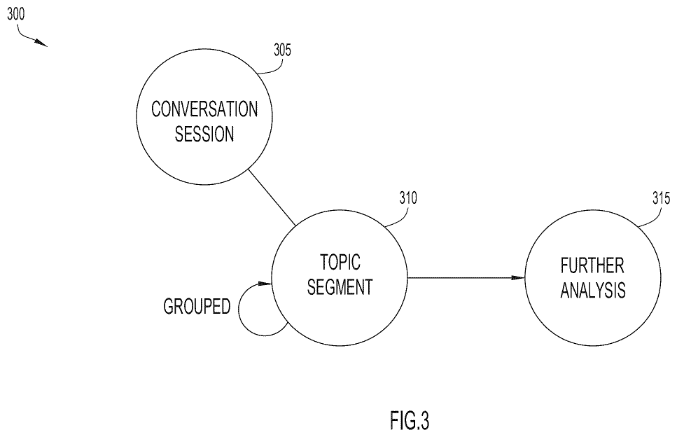

A method 300 of identifying and tracking topics during a conversation (e.g., via AI conversation code 200 and computer 101, etc.) according to an embodiment of the present invention is illustrated in FIG. 3. Initially, AI conversation code 200 generates an interactive, natural language, conversation or other communication session with a user at operation 305. The conversation session contains topic segments that are identified during the conversation flow at operation 310. For example, the conversation is monitored for transitions between topics. Conversation content occurring during a topic is associated with the topic and forms the topic segment (e.g., a segment of conversation content associated with the topic, etc.). When a change to the topic is identified, new content occurring during the changed topic is associated with the changed topic and forms a new topic segment (e.g., a segment of conversation content associated with the changed topic).

When the changed topic is a new topic (e.g., not pre-existing, etc.), topics that are related to the new topic are discovered and grouped with the new topic as the conversation evolves. The related topics may be discovered by accessing and searching an ontology registry. By way of example, the ontology registry includes nodes representing business concepts, and edges indicating relationships between nodes. The ontology registry may be generated using any conventional or other techniques (e.g., pre-established for specific industries, generated based on industry concepts, generated based on natural language processing, etc.).

Once the topic segments are generated, they may be used for various future analysis at operation 315 (e.g., generating summaries for topics, eliciting further inquiries, etc.). Topics within plural different conversations may be monitored and tracked in substantially the same manner described above. For example, a same topic may be within different conversations, and a plurality of segments from the different conversations may be assigned to the same topic. Thus, a search for the topic may provide the segments from the different conversations corresponding to the topic.

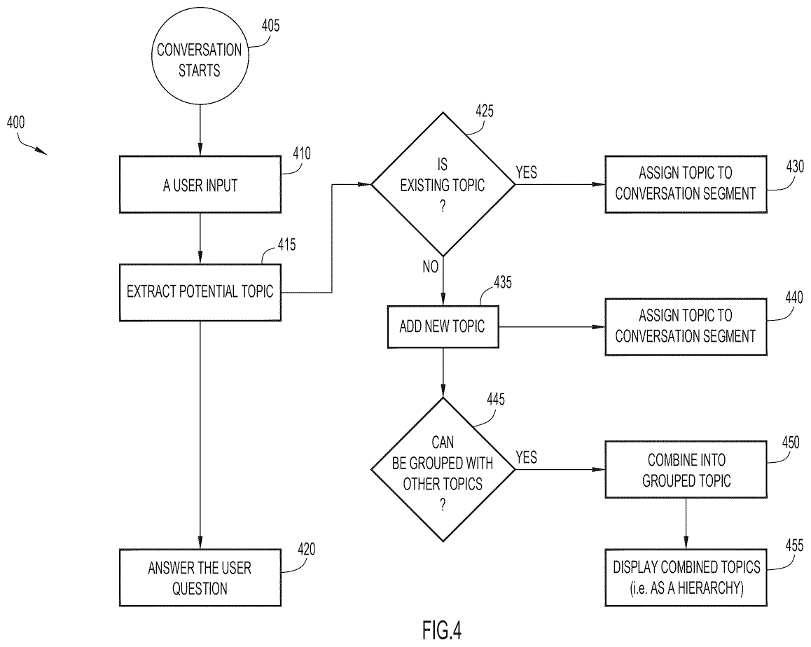

A method 400 of identifying topics and grouping related topics during a conversation (e.g., via AI conversation code 200 and computer 101, etc.) according to an embodiment of the present invention is illustrated in FIG. 4. Initially, AI conversation code 200 generates an interactive, natural language, conversation or other communication session with a user at operation 405. The user may provide user input (e.g., an inquiry, further details and/or inquiries, responses, etc.) to the conversation at operation 410.

A potential topic is extracted from the conversation based on the user input at operation 415, and AI conversation code 200 produces an answer for the question at operation 420. The AI conversation code may use any conventional or other machine learning and/or natural language processing techniques to provide the answer. The conversation is monitored to detect when the user input triggers creating a new topic, merges with another topic, or continues with an existing topic. A topic may include, or be associated with, a set of data contexts (e.g., structured data definitions, business intelligence domain concepts, business-defined key performance indicators (KPIs), metrics, semantics, etc.). The data contexts provide attributes of the topic (or entities) for corresponding data (e.g., metric, location, time, etc.). When one or more of the data contexts or attributes of a topic change, the topic is considered to be changed. By way of example, each inquiry or question from the user may include: an intent (e.g., questions related to what, how, show, where, why, etc.); an entity (e.g., product, store, department, sales, revenue, and generally what a business user would ask about or create a key performance indicator (KPI) against within an organization domain); and a scope, filter, or modifier (e.g., top, list, average, specific date, or other attributes that applies to the entity).

Entities are used to determine the topic. For example, when the user is asking about similar or related entities, the topic remains the same. The conversation is monitored to associate or assign segments of conversation content to a topic. A transition or change in a topic for assigning conversation content or segments is determined during the conversation session (e.g., as the conversation flows, in real-time, etc.). This enables a current segment of the conversation to be assigned to the current topic, and successive conversation content to be associated with the changed topic and form a topic segment for the changed topic (e.g., identify another topic to break from a current topic segment, etc.).

Initially, the user input is analyzed to extract the entities. This may be accomplished using any conventional or other machine learning and/or natural language processing techniques (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.). The entities are mapped to concepts using the ontology registry. The concepts may be business or other industry names and/or categories (e.g., products, financial key performance indicators (KPIs)), etc. The mapping basically provides a (business or other industry) meaning for the entities. By way of example, the ontology registry includes nodes representing business concepts, and edges indicating relationships between nodes. The ontology registry may be generated using any conventional or other techniques (e.g., pre-established for specific industries, generated based on industry concepts, generated based on natural language processing, etc.).

A textual embedding is created for the extracted entities, and the resulting vector representation is used to calculate a distance between a previous entity (e.g., from a prior user input or question, etc.) and the extracted entities from the user input. When the distance indicates the embeddings between the current and prior entities are close (e.g., absolute delta is under approximately 0.3, etc.), the entities are considered sufficiently related to not create a changed or different topic. Any conventional or other distance measure may be used (e.g., Euclidean distance, cosine similarity, etc.).

For example, a first question may include “What are the sales trends in my European stores?” In this case, the intent is what, the entity is sales, and the scope/modifier is trend in European stores. A second question may include “How are the profits in these stores?” In the case of the second question, the intent is how, the entity is profits, and the scope/modifier is European stores. Since the entities (profit and sales) from the questions belong to a same higher-level concept in the ontology registry (e.g., financial data, etc.), the topic is considered to be the same.

A third question may include “What is the current inventory level for my top selling product?” In the case of the third question, the intent is what, the entity is inventory level, and the scope/modifier is top selling product. Since inventory is an entity that maps to a different concept (product) in the ontology registry than the entities of profit and sales, a changed topic is considered to be present.

Once a topic change is identified in the conversation, the changed topic may be an existing topic or a new topic. When the changed topic is an existing topic as determined at operation 425, the existing topic is assigned to the conversation segment at operation 430. For example, topic coordinator 220 (FIG. 2) may convert extracted entities to textual embeddings, and search the existing topics stored in embedding database 245. When a matching topic is identified (e.g., having the same embedding, having an embedding within a threshold distance of the embedding of the entities and concepts, etc.), the conversation segment is assigned to the existing topic. By way of example, the segment may be assigned to the topic by updating index 222 to indicate the segment is associated with the topic (e.g., add a segment indicator or content for the topic in the index, etc.) in substantially the same manner described above.

When the changed topic is a new topic, the new topic is added and assigned to the conversation segment at operations 430, 435. For example, topic coordinator 220 (FIG. 2) generates a new topic (based on the entities) and adds the new topic (or the embedding of the new topic) to embedding database 245 which can be used for subsequent conversation segments. The segment may be assigned to the new topic by updating index 222 to indicate the new topic and corresponding segment in substantially the same manner described above.

Topic coordinator 220 (FIG. 2) further compares the new topic with existing topics to determine an existence of a relationship based on an ontology registry. When the topics are related as determined at operation 445, the topics are grouped together at operation 450 and presented to the user (e.g., as a hierarchy, etc.) at operation 455. The segment may be assigned to the group of topics by updating index 222 to indicate the segment is associated with the group of topics in substantially the same manner described above.

The topics may be grouped in an arrangement or hierarchy based on the ontology registry. By way of example, the ontology registry includes nodes representing business concepts, and edges indicating relationships between nodes. The ontology registry may be generated using any conventional or other techniques (e.g., pre-established for specific industries, generated based on industry concepts, generated based on natural language processing, etc.). The grouping of topics enables precise content to be retrieved without having to search through the various topics in the conversation. In other words, the group of topics may be searched as a search entity or object (via index 222) to reduce search results and quickly identify corresponding conversation content pertaining to the topic group.

Topics within plural different conversations may be monitored, tracked, and grouped in substantially the same manner described above. For example, a same topic (or topic group) may be within different conversations, and a plurality of segments from the different conversations may be assigned to the same topic (or topic group). Thus, a search for the topic (or topic group) may provide the segments from the different conversations corresponding to the topic.

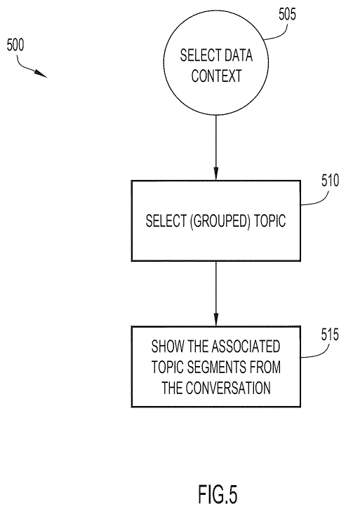

A method 500 of searching a conversation for a desired topic (e.g., via AI conversation code 200 and computer 101, etc.) according to an embodiment of the present invention is illustrated in FIG. 5. Initially, AI conversation code 200 generates one or more interactive, natural language, conversations or other communication sessions with users. The users may provide user input (e.g., an inquiry, further details and/or inquiries, responses, etc.) to the conversations. The data topics and corresponding conversation segments are identified and tracked during the one or more conversations in substantially the same manner described above.

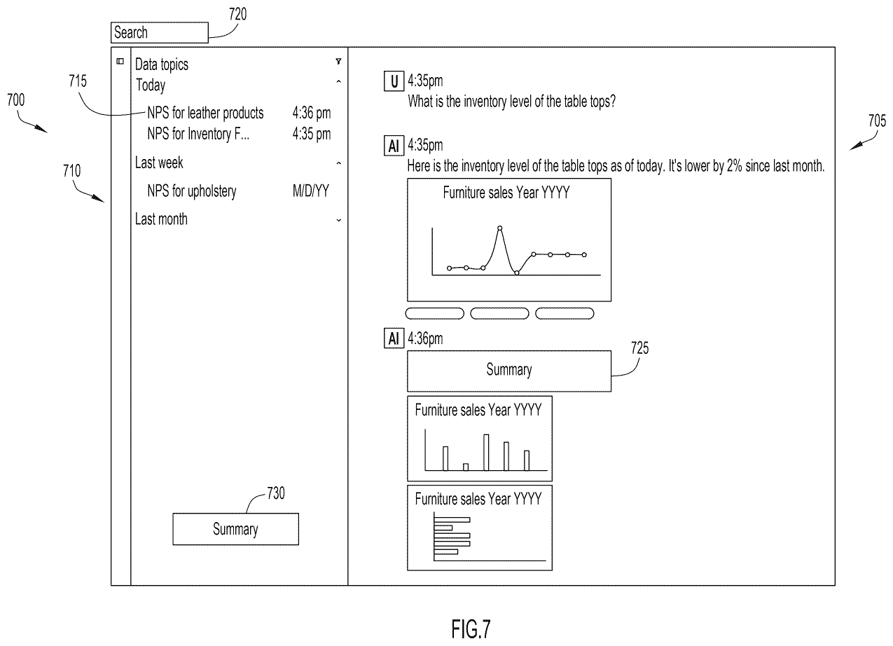

At a later time (e.g., after participation in a conversation, a later time during the conversation, etc.), a user may desire to return to a portion of the one or more conversations pertaining to a desired topic (e.g., content, visualizations, etc.). The user may select or enter a desired data context at operation 505 and a topic (grouped or ungrouped) at operation 510. The data context and topic may be selected or entered on a user interface (e.g., as described below for FIG. 7). In addition, conversations may be pre-selected (e.g., all existing conversations selected, one conversation exists and is selected, conversations with the user selected, etc.), or the user may enter or select one or more specific conversations (when more than one conversation exists) based on criteria or identifiers (e.g., recency of conversation, etc.).

The data context and topic are used to search index 222 (FIG. 2) for associations between segments and corresponding topics for the selected conversations. The segments contain conversation content pertaining to the associated data context and topic from the one or more conversations. The index may provide conversation content or locations of the conversation content within the selected conversations corresponding to the entered data context and topic. The associated segments for the data context and topic are retrieved (e.g., from the index, storage/buffer containing conversation content, etc.) and presented to the user (e.g., on the user interface) at operation 515.

In addition, a summary of the conversation content identified by the search may be generated and presented to the user. A user may also request a summary based on an actuator on the user interface. The summary may contain any portions of the corresponding conversation content (e.g., business insights, metrics, graphs and/or other visualizations, etc.).

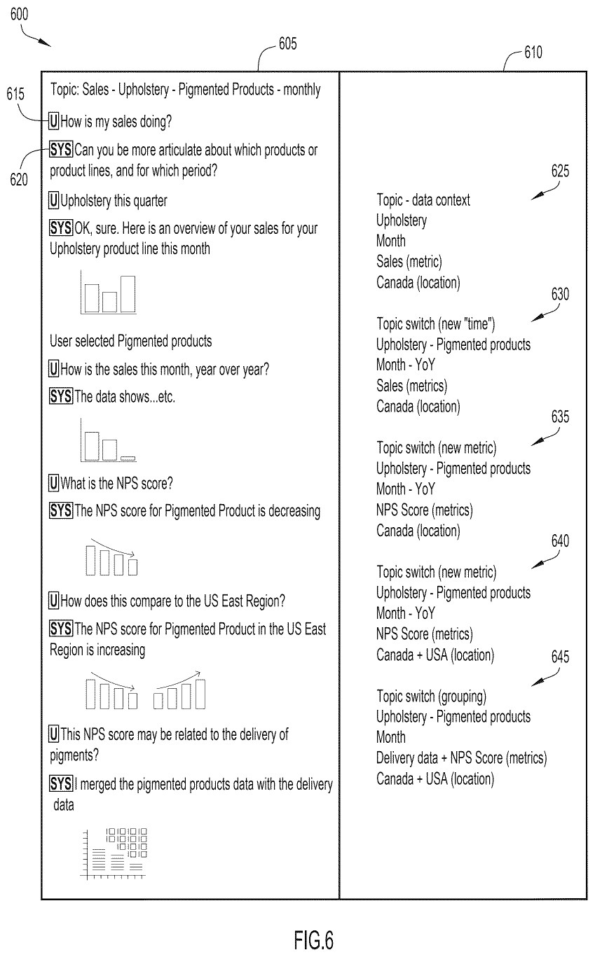

An example user interface presenting a generative artificial intelligence (AI) conversation with corresponding identified data topics according to an embodiment of the present invention is illustrated in FIG. 6. Initially, a user asks a question about their business, and the system performs a query. This query defines the topic (e.g., business dimension, time period, measure (metric), and location for business intelligence). User interface 600 includes a conversation area 605 and a topic area 610. Conversation area 605 presents the content of the conversation, including a series of user inquiries/replies 615 (e.g., indicated as U in FIG. 6) and system responses 620 (e.g., indicated as SYS in FIG. 6) including text and/or visualizations.

The system monitors the user input to the conversation to determine when a topic transition or change occurs. Topic area 610 indicates the topic transitions along the corresponding content of the conversation. For example, a user inquiry concerning upholstery this quarter is detected in substantially the same manner described above to trigger a topic initialization 625. The topic initialization indicates the topic and corresponding data contexts (e.g., upholstery, month, sales, and Canada). The corresponding conversation content or segment is assigned to the initial topic via index 222 (FIG. 2) in substantially the same manner described above.

A second user inquiry concerning upholstery this month year-over-year (YOY) is detected in substantially the same manner described above to trigger a topic switch 630. The topic switch indicates the changed topic and data context (e.g., new time, upholstery—pigmented products, month—YOY, sales, Canada). The system understands the relationship between the entities (based on the ontology registry) and may arrange the topics accordingly (e.g., nested, hierarchically, etc.). The corresponding conversation content or segment is assigned to the changed topic via index 222 (FIG. 2) in substantially the same manner described above.

A third user inquiry concerning a net promoter score (NPS) is detected in substantially the same manner described above to trigger a topic switch 635. The topic switch indicates the changed topic and context (e.g., new metric, upholstery—pigmented products, month—YOY, NPS score, Canada). The corresponding conversation content or segment is assigned to the changed topic via index 222 (FIG. 2) in substantially the same manner described above.

A fourth user inquiry concerning a different location is detected in substantially the same manner described above to trigger a topic switch 640. The topic switch indicates the changed topic and context (e.g., new metric, upholstery—pigmented products, month—YOY, NPS score, Canada and USA). The corresponding conversation content or segment is assigned to the changed topic via index 222 (FIG. 2) in substantially the same manner described above.

A fifth user inquiry concerning merging of pigmented products data with delivery data is detected in substantially the same manner described above to trigger a topic switch 645. The topic switch indicates the changed topic and new context (e.g., grouping, upholstery—pigmented products, month, delivery data and NPS score, Canada and USA). The corresponding conversation content or segment is assigned to the changed topic via index 222 (FIG. 2) in substantially the same manner described above.

The user may utilize the topics (and context) to search the conversation to identify specific content pertaining to the topic (and context) in substantially the same manner described above. For example, at some later point in time (e.g., days, weeks, months, etc.), the user may return to the conversation session, select a topic (and context) about net promoter score (NPS), Canada, US, etc., and is presented with the corresponding conversation segment (e.g., text, visualizations, etc.). The topic segments may be used across different conversations to perform further analysis. A specific topic segment may be searched by description, metric (measure), and/or time frame. The collection of topic segments can also be used to analyze conversation topics over time across different conversation sessions, using sort/filter operation, where the data could be used for further improvement of the artificial intelligence (AI).

In addition, conversation content may automatically be summarized after a certain time or date, and the summary presented in conversation area 605. A user may also request a summary based on an actuator (e.g., on the user interface). The summary may contain any portions of the corresponding content (e.g., business insights, metrics, graphs and/or other visualizations, etc.).

An example user interface 700 presenting an example generative artificial intelligence (AI) conversation with corresponding identified topics used to locate desired portions of the conversation according to an embodiment of the present invention is illustrated in FIG. 7. Initially, a user asks a question about their business, and the system performs a query. This query defines the data topic (e.g., business dimension, time period, measure (metric), and location for business intelligence). User interface 700 includes a conversation area 705 and a topic area 710. Conversation area 705 presents the content of the conversation, including a series of user inquiries/replies (e.g., indicated as U in FIG. 7) and system generated responses (e.g., indicated as AI in FIG. 7) including text and/or visualizations.

The system monitors the user input to the conversation to determine when a topic transition or change occurs in substantially the same manner described above. Topic area 710 indicates topics 715 identified in the conversation. The user may utilize the topics to search the conversation to identify specific content (e.g., text, graphs and/or other visualizations, etc.) pertaining to the topic in substantially the same manner described above. In this example case, topics 715 are provided in the form of links. Actuation of a link 715 presents the conversation segment or content, and/or a summary of the conversation segment or content, associated with the topic in conversation area 705. The links may be presented in chronological or other order based on time within the conversation (e.g., oldest to newest, newest to oldest, etc.). In addition, conversation content may automatically be summarized after a certain time or date, and a summary 725 may be presented in conversation area 705. A user may also request a summary of a selected conversation portion based on a separate actuator 730 (e.g., on user interface 700). The summary may contain any portions of the corresponding content (e.g., business insights or metrics, graphs and/or other visualizations, etc.).

In addition, topic area 710 of user interface 700 may further include a search bar 720. A user may enter desired topics and context into the search bar to search the conversation for the desired topics and/or context via index 222 (FIG. 2) in substantially the same manner described above. The topic and data context are used to search the index for associations between segments and corresponding topics and context. The index may provide corresponding segments, and/or pointers to segments, that contain conversation content (e.g., text, graphs and/or other visualizations, etc.) pertaining to the topic and context. The associated segments for the topic and context are retrieved (e.g., from the index, storage/buffer, etc.) and presented to the user (e.g., in conversation area 705 of user interface 700).

Present invention embodiments provide various technical and other advantages. For example, present invention embodiments significantly improve search time. Specific data topics may be easily identified when hidden or embedded in a long conversation (that otherwise requires a user to scroll through multiple keyword search results to find a specific data topic). This saves time and processing effort, and reduces duplication, thereby reducing a need for extra analysis. Present invention embodiments intelligently organize and categorize conversation topics to enable rapid searching and identification of precise locations in the conversation, and automatically summarize content to reduce amounts of data transferred. The conversations may use a topic-based index to provide locations, or content, for topics. This index enables rapid searching of the conversation. Further, the index may apply across multiple conversations to enable rapid searching of content from across those conversations. For example, a topic may rapidly provide content associated with the same or similar topic from plural different conversations. Conversations may be filtered by data topic, thereby eliminating unnecessary and irrelevant content.

Further, the conversation may include various data visualizations (e.g., graphs, charts, etc.). The data topics may be used to rapidly locate the visualizations in the conversation. Thus, present invention embodiments provide a visualization search engine that rapidly identifies visualizations in a conversation based on topics. Further, the data topics may be in the form of links or hyperlinks on a user interface, where actuation of the link provides the content for the corresponding topic (e.g., displays the topic, navigates to the location of the topic in the conversation, etc.). This enables fast identification of desired content, and reduces processing since the links may enable navigation to the corresponding conversation portion with desired content.

It will be appreciated that the embodiments described above and illustrated in the drawings represent only a few of the many ways of implementing embodiments for a search engine for conversations based on data topic segment identification.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., AI conversation code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., conversation content, visualizations, search terms, topics, data contexts, embeddings, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., conversation content, visualizations, search terms, topics, data contexts, embeddings, etc.).

The present invention embodiments are not limited to the specific tasks or algorithms described above, but may be utilized for identifying and tracking topics pertaining to any industry or subject matter within an AI or other conversation or communication session for searching any type of content (e.g., text, visualizations, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of searching conversations for desired content comprising:
monitoring, via at least one processor, a conversation;
extracting, via the at least one processor and based on monitoring the conversation, a set of entities from the conversation;
converting, via the at least one processor, the set of entities to a textual embedding;
partitioning, via the at least one processor, a portion of the conversation into a segment based on converting the set of entities to a textual embedding;
processing, via the at least one processor, a query including a topic; and
retrieving, via the at least one processor, the segment based on processing the query.

2. The method of claim 1, wherein the conversation is generated by artificial intelligence.

3. The method of claim 1, further comprising:
determining a presence of a change from the topic to a different topic, wherein determining the presence of the change comprises:
extracting another set of entities from an inquiry of a user during another portion of the conversation;
generating a textual embedding of the other set of entities; and
determining the presence of the change from the topic to the different topic based on a distance between the textual embedding of the other set of entities and the textual embedding of the set of entities.

4. The method of claim 1, wherein partitioning the portion of the conversation into the segment comprises:
assigning the segment to the topic based on determining that the segment is associated with the topic, wherein the topic is an existing topic.

5. The method of claim 1, wherein partitioning the portion of the conversation into the segment comprises:
assigning the segment to the topic based on determining that the segment is associated with the topic, wherein the topic is a new topic.

6. The method of claim 1, wherein partitioning the portion of the conversation into the segment further comprises:
determining one or more topics related to the topic based on an ontology;
arranging the topic and the one or more related topics according to relationships from the ontology; and
presenting the topic and one or more related topics arranged according to the relationships adjacent a corresponding segment of a conversation.

7. The method of claim 1, further comprising:
presenting, via the at least one processor, changes in topics for the conversation adjacent segments of the conversation corresponding to the changes in topics.

8. The method of claim 1, further comprising:
monitoring a plurality of conversations; and
retrieving segments, including the segment, of the plurality of conversations pertaining to the topic of the query.

9. A system for searching conversations for desired content comprising:
one or more memories; and
at least one processor coupled to the one or more memories and configured to:
monitor, via at least one processor, a conversation;
extract, via the at least one processor and based on monitoring the conversation, a set of entities from the conversation;
convert, via the at least one processor, the set of entities to a textual embedding;
partition, via the at least one processor, a portion of the conversation into a segment based on converting the set of entities to a textual embedding;
process, via the at least one processor, a query including a topic; and
retrieve, via the at least one processor, the segment based on processing the query.

10. The system of claim 9, wherein the conversation is generated by artificial intelligence.

11. The system of claim 9, wherein the at least one processor is further configured to:
determine a presence of a change from the topic to a different topic, wherein determining the presence of the change comprises:
extracting another set of entities from an inquiry of a user during another portion of the conversation;
generating a textual embedding of the other set of entities; and
determining the presence of the change from the topic to the different topic based on a distance between the textual embedding of the other set of entities and the textual embedding of the set of entities.

12. The system of claim 9, wherein partitioning the portion of the conversation into the segment comprises:
assigning the segment to the topic based on determining that the segment is associated with the topic, wherein the topic is an existing topic.

13. The system of claim 9, wherein partitioning the portion of the conversation into the segment comprises:
assigning the segment to the topic based on determining that the segment is associated with the topic, wherein the topic is a new topic.

14. The system of claim 9, wherein partitioning the portion of the conversation into the segment further comprises:
determining one or more topics related to the topic based on an ontology;
arranging the topic and the one or more related topics according to relationships from the ontology; and
presenting the topic and one or more related topics arranged according to the relationships adjacent a corresponding segment of a conversation.

15. The system of claim 9, wherein the at least one processor is further configured to:
present changes in topics for the conversation adjacent segments of the conversation corresponding to the changes in topics.

16. The system of claim 9, wherein the at least one processor is further configured to:
monitor a plurality of conversations; and
retrieve segments, including the segment, of the plurality of conversations pertaining to the topic of the query.

17. A computer program product for searching conversations for desired content, the computer program product comprising one or more computer readable storage media having program instructions collectively stored on the one or more computer readable storage media, the program instructions executable by at least one processor to cause the at least one processor to:
monitor a conversation;
extract, based on monitoring the conversation, a set of entities from the conversation;
convert the set of entities to a textual embedding;
partition a portion of the conversation into a segment based on converting the set of entities to a textual embedding; and
process a query including a topic; and
retrieve the segment based on processing the query.

18. The computer program product of claim 17, wherein the conversation is generated by artificial intelligence.

19. The computer program product of claim 17, wherein the program instructions further cause the at least one processor to:
determine a presence of a change from the topic to a different topic, wherein determining the presence of the change comprises:
extracting another set of entities from an inquiry of a user during another portion of the conversation;
generating a textual embedding of the other set of entities; and
determining the presence of the change from the topic to the different topic based on a distance between the textual embedding of the other set of entities and the textual embedding of the set of entities.

20. The computer program product of claim 17, wherein partitioning the portion of the conversation into the segment comprises:
assigning the segment to the topic based on determining that the segment is associated with the topic, wherein the topic is an existing topic.

21. The computer program product of claim 17, wherein partitioning the portion of the conversation into the segment comprises:
assigning the segment to the topic based on determining that the segment is associated with the topic, wherein the topic is a new topic.

22. The computer program product of claim 17, wherein partitioning the portion of the conversation into the segment further comprises:
determining one or more topics related to the topic based on an ontology;
arranging the topic and the one or more related topics according to relationships from the ontology; and
presenting the topic and one or more related topics arranged according to the relationships adjacent a corresponding segment of a conversation.

23. The computer program product of claim 17, wherein the program instructions further cause the at least one processor to:
present changes in topics for the conversation adjacent segments of the conversation corresponding to the changes in topics.

24. The computer program product of claim 17, wherein the program instructions further cause the at least one processor to:
monitor a plurality of conversations; and
retrieve segments, including the segment, of the plurality of conversations pertaining to the topic of the query.
